(19) United States
(12) Patent Application Publication
(10) Pub. No.: US 2010/0127446 A1
(43) Pub. Date: May 27, 2010

(54) Device for Hidden and Re-Detachable Connections, and Tools for the Assembly Thereof

(76) Inventor: Werner Dörig, Lustmuhle (CH)

Correspondence Address: JOHN ALEXANDER GALBREATH, 2516 CHESTNUT WOODS CT, REISTERSTOWN, MD, 21136, US

(21) Appl. No.: 12/373,064

(22) PCT Filed: Jul. 27, 2007
(86) PCT No.: PCT/CH2007/000370

§ 371 Date: Jan. 9, 2009

(30) Foreign Application Priority Data
Aug. 8, 2006 (CH) 1275/06

(51) Int. Cl. B23Q 1/00

(52) U.S. Cl. 269/53

(57) ABSTRACT

Provided are at least two connecting elements (3, 4) which engage into one another, a first connecting element of which is to be arranged on a workpiece (1) and a second of which is to be arranged on a surface (2) to which the workpiece (1) is to be fastened. At least one of the connecting elements (3, 4) has at least one locking arrangement (8), with the purpose of being able to fixedly clamp said connecting element (3, 4) in its position on the workpiece (1) or on the surface (2). The connecting elements (3, 4) can be arranged in a sleeve (9) which holds said connecting elements and which itself is fixedly held by means of a second locking arrangement (10) in a depression (5, 6) of the workpiece (1) or of the surface (2). For reliable and comfortable assembly of said device, special tools are provided. The device is especially suitable for workpieces (1) and/or surfaces (2) to which previous connecting elements could not be fastened or could be fastened only with difficulty, for example light building boards.

The present invention relates to a device for invisibly and detachably connecting two surfaces whereof at least one surface belongs to a mobile workpiece and which comprises at least two interlocking connecting elements, whereof a first connecting element is to be arranged on the workpiece and a second one is to be arranged on the surface to which the workpiece is to be attached. Furthermore the invention relates to tools for mounting this device, i.e. a marking gauge, a pair of clamping tongs, a securing key and a marking tool.

Cup shaped connecting elements to be arranged in drilling holes are known from CH 662 599 of the same applicant. They are used to mount workpieces like veneered or coated panel units and wall coverings. Furthermore to fit the outer half of entry doors or sound-absorbing doors. Ultimately there are hardly any limits to the possible uses. Generally these connecting elements have proven themselves to be excellent. In practice it has been shown, however, that there is an increasing amount of uses where surfaces need to be connected to each other but where the previous connecting elements cannot be attached at all or only with great difficulty. This is the case, for example, for lightweight building boards with honeycomb structure. In the honeycomb core the connecting elements do not have sufficient stability nor can they be screwed on. Based on this realization, the objective of the invention is to create a device for invisible and detachable connections which keep the above mentioned problems from occurring. Furthermore, a marking gauge for exact mounting of the device is described, as well as special clamping tongs for clamping the device to a surface, a securing key for depressing securing tabs and a marking tool for determining the orientation of the device.

The device according to the invention corresponds to the characteristic features of patent claim 1. The marking gauge is described in patent claim 18, the clamping tongs in patent claim 23, the securing key in patent claim 27 and the marking tool in patent claim 29. Further advantageous embodiments of the inventive idea are apparent from the dependent patent claims.

Hereinafter preferred exemplary embodiments of the invention are specified by means of the drawings.

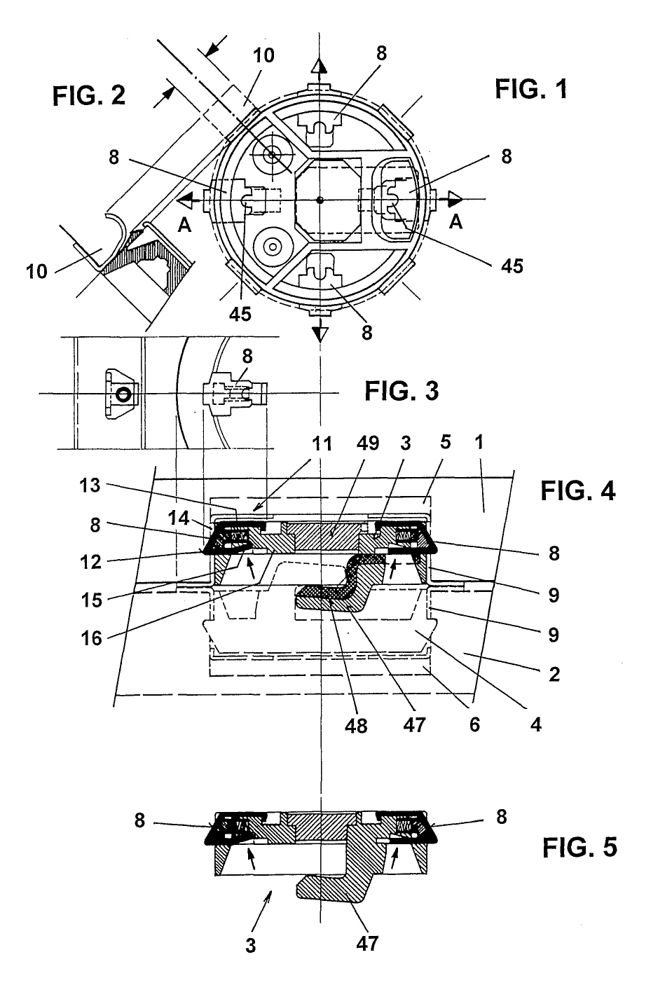

FIGS. 1-3 show a view and partial views of a device with a connecting element,

FIGS. 4-5 show a sectional view along line A-A of the device and of the connecting element according to FIG. 1, respectively,

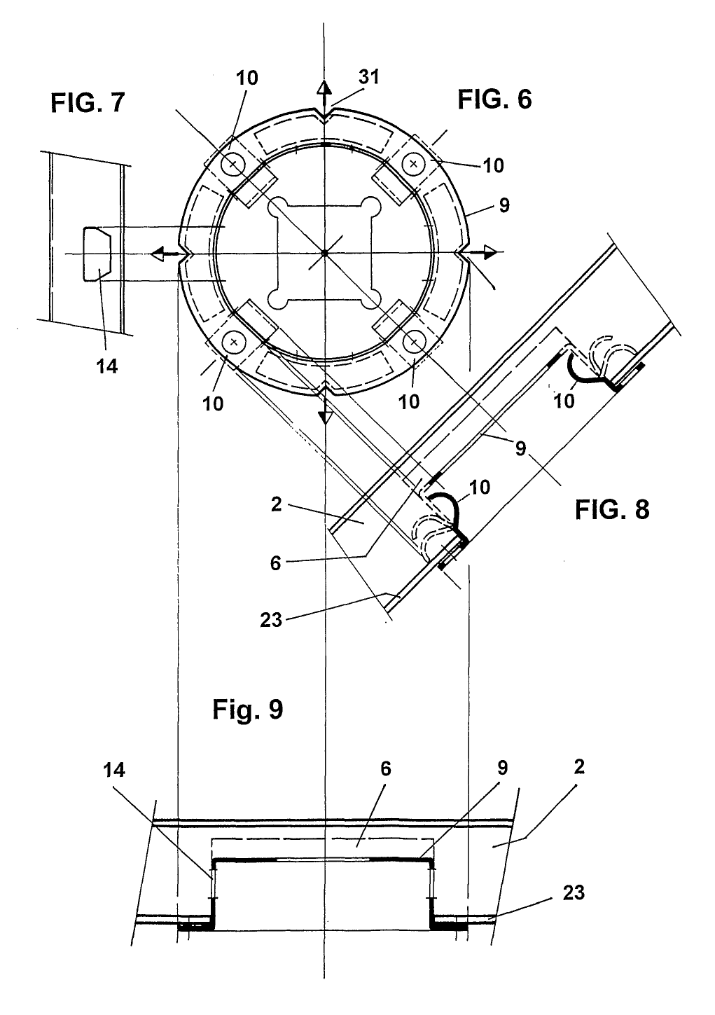

FIGS. 6-9 show a sleeve for receiving the connecting element according to FIGS. 1-5,

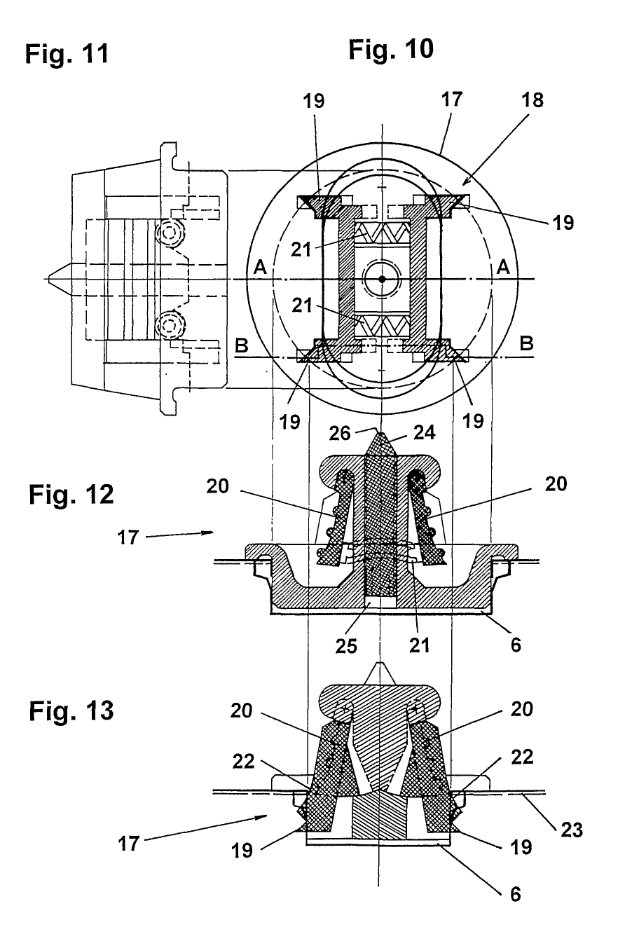

FIGS. 10-13 show a marking gauge for mounting the device according to FIGS. 1-9,

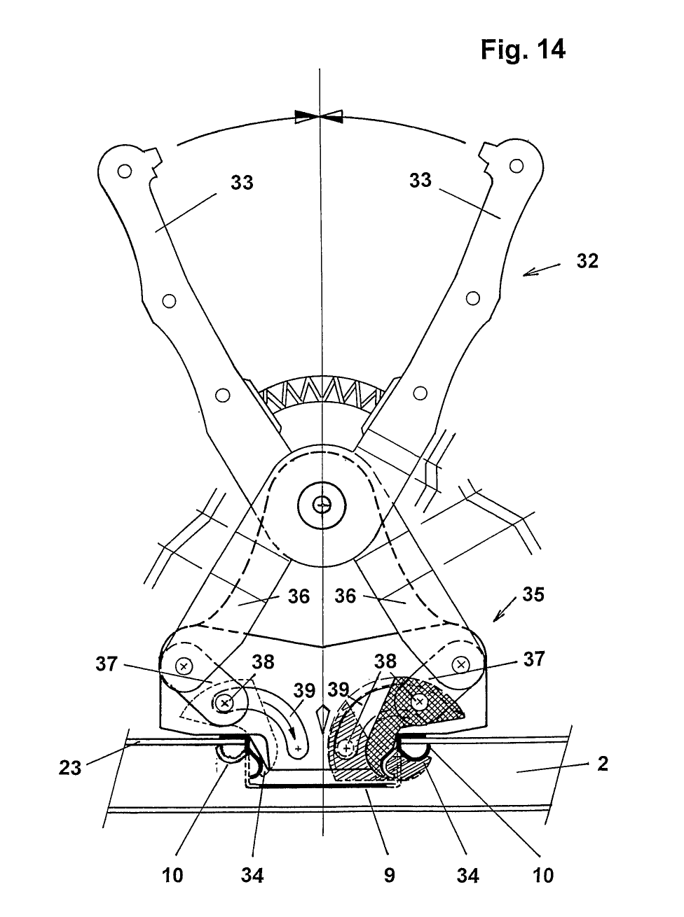

FIG. 14 shows clamping tongs for mounting the device according to FIGS. 1-9,

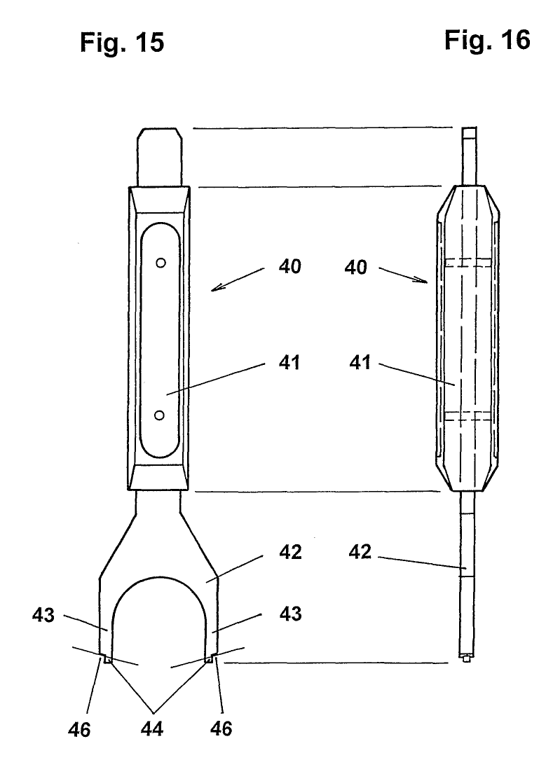

FIGS. 15-16 show a securing key for mounting the connecting element according to FIGS. 1-5,

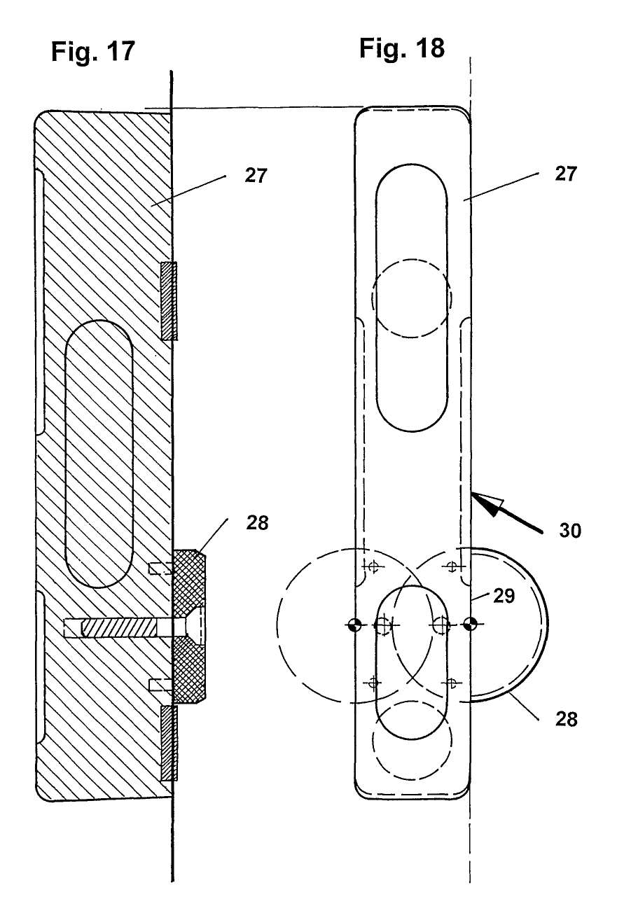

FIGS. 17-18 show a marking tool for mounting the device according to FIGS. 1-9,

To mount a workpiece 1 to a surface 2, two interlocking connecting elements 3 and 4 are provided. Of those, for example can-shaped connecting elements 3 and 4, a first connecting element 3 is to be arranged on a workpiece 1 and a second connecting element 4 is to be arranged on a surface 2. This second connecting element is marked in FIG. 4 by a dotted line. To arrange the connecting elements 3 and 4 on the workpiece 1 and on the surface 2, respectively, a recess 5 and 6 is placed at a predetermined location into the workpiece 1 and the surface 2, preferably by use of a drill. To fit these recessions 5 and 6 exactly on top of each other, a marking gauge with a center point is placed into the first drilled recess 5 or 6, as described in the state of the art mentioned in the beginning. The work piece 1 is then pressed in the right position against surface 2 so that the center point leaves a depression which will serve as mark for drilling the second recess 5 or 6. This ensures that the recesses 5 and 6 and the connecting elements 3 and 4 to be arranged therein will be placed exactly on top of each other. The newly developed marking gauge will be explained later.

According to the invention, the connecting elements 3 and 4 comprise at least one locking device 8 according to FIGS. 1 to 5 which has the purpose of clamping or gripping the respective connecting element 3 or 4 in place. This can be accomplished either directly inside the recess 5 or 6 of the workpiece 1 or the surface 2 or—as is the case in the present embodiment—in an additional sleeve 9 which receives the respective connecting element 3 or 4. An example of a sleeve 9 is shown in detail in FIGS. 6 to 9. The sleeve 9 can itself comprise at least one locking device 10 for clamping it securely inside the recess 5 or 6 of the workpiece 1 or the surface 2 respectively. As can be seen especially in FIG. 9, the sleeve 9 can comprise a flange. This flange can rest on surface 2 as shown. Depending on the material structure of the surface 2, a mounting with a countersunk flange is also possible.

In the embodiment according to FIGS. 4 and 5 the locking device 8 of the connecting elements 3 and 4 comprises a latch element 11. It comprises at least one projection 12 designed to engage with the sleeve 9 and/or with the recess 5 or 6 of the workpiece 1 or the surface 2 respectively. The latch element 11 shown here can be slideably moved against the force of a spring 13 which presses the projection 12 into the wall of the sleeve 9 and/or into the wall of the recess 5 or 6. In the present case the wall of the sleeve 9 comprises at least one engaging site 14 for each projection 12, for example in form of a notch or a punching. Preferably the locking device 8 or its latch element 11, respectively, are secured against accidental release. The latch element 11 can, for example, comprise a bar 15 which, after pushing it down according to the arrows, rests against a stationary locking element 16. The locking element 16 can be formed in a step-like manner as shown, so that the latch element 11 is freely movable prior to being pushed down against the force of the spring 13 as mentioned above. Due to the bevel of the projection 12 (also shown), the latch element 11 is pushed back when the connecting element 3 or 4 is inserted into the sleeve 9 and doesn't snap into place until it reaches the area of the engaging site 14. The locking devices 10 of the sleeve 9 are, for example, hook or claw shaped. A crossectional straight shape is also possible but less effective. They can be punched out of the wall of the sleeve 9 and/or be formed from it. By bending they can be moved into the desired locking position. Because only the wall of the sleeve 9 or its respective engaging site 14 is necessary for fastening the connecting element 3 or 4, the sleeve 9 can also be designed without bottom and with perforated walls. In theory a design with multiple parts is possible but less sensible. The term sleeve 9, therefore, needs to be understood comprehensively.

Marking gauge 17 is provided to mount the connecting elements 3 and 4 in their respectively correct position. It is shown in FIGS. 10 to 13. A perfectly round marking gauge with a center point is know from CH 662 599 mentioned in the beginning. If the diameter of recess 5 or 6, in which the marking gauge is to be inserted, is only slightly bigger, the marking gauge slides around in this recess 5 or 6 leading to inaccuracies when marking. The result may be that the workpiece 1 can not be mounted, because absolute accuracy is necessary. Another disadvantage of the previous marking gauge is that it can fall out of recess 6 when working on a vertical wall. Furthermore the center point can get caught and therefore tilt when aligning the workpiece 1. The mark can, therefore, be placed in the wrong position without this being noticed. Lastly, the known marking gauge cannot be used especially with lightweight building boards with honeycomb structure. It will not find sufficient stability in the honeycomb core.

With the marking gauge 17 according to the invention these disadvantages are effectively prevented. It is not just inserted into the recess 5 or 6 but is securely fastened therein. For this purpose it comprises a clamping device 18. In the present exemplary embodiment this device causes claws or points 19 to be pressed into the wall of recess 6. See FIG. 10 and FIG. 13, showing a sectional view along line B-B in FIG. 10. When inserting the marking gauge 17, the handle parts 20 are pressed together. They are pushed apart by at least one spring 21. See also FIG. 10 and FIG. 12, showing a sectional view along line A-A in FIG. 10. After releasing the handle parts 20, the claws or points 19 hold the marking gauge 17 immovably in place in the recess 6. In lightweight building boards the claws or points 19 open to the extent that the clamp element 22 above the claws or points 19 rests against the surface layer 23 of the lightweight building board and holds the marking gauge 17 in place. The only requirement is a surface layer 23 of sufficient wall thickness, for example, depending on the material, 0.8mm. The center point 24 can, for example, be designed to be adjustable from the back regarding its height and penetration depth. In the present case it is screwable with an Allen wrench. The center point 24 can comprise a slightly dull end 26. Thus workpiece 1 can be moved during positioning without being caught immediately by center point 24. The desired mark is formed only when workpiece 1 is pressed against it. Slight inaccuracies of recess 6 are compensated by marking gauge 17 according to the invention. Working on a vertical wall and even on a ceiling are now possible without any problems. A tilting of the marking gauge 17, leading to wrong marks, is not possible anymore as well.

Due to the marking gauge 17, the second recess 5 or 6 can be placed with an exact fit to the position of the first recess 5 or 6. After that the connecting elements 3 and 4 or—as in the present example—the respective sleeve 9 can be inserted. To align these exactly, a marking tool 27 according to FIGS. 17 and 18 can be used. With the marking tool 27 the absolutely necessary alignment of connecting elements 3 and 4 to each other can be ensured. In the embodiment shown in the drawing a sleeve 9 is inserted first, therefore its alignment needs to be established. For this purpose the marking tool 27 comprises a peg 28 which fits into the recess 5 or 6. The peg 28 in the present example is arranged offset to one side on the marking tool 27. In any case the marking tool 27 comprises an edge 30 which extends the axle center 29 of the peg 28 at least in one direction. Along this edge 30 the axle center 29 at the edge of recess 5 or 6 can be extended or marked with a commercially available scriber. The sleeve 9 can then be easily positioned in such a way that their markings 31 are placed exactly in the marked axle center 29, because the markings 31 themselves indicate the axle center of the sleeve 9. In the present example the markings 31 are comprised of one indentation each on the circumference of the sleeve 9. This has the advantage that the markings 31 are clearly visible but will not damage the workpiece 1 or the surface 2 when the sleeve 9 is inserted. Projections or any other kind of marking would also be possible, for example, by merely scratching the flange of the sleeve 9 through the indentation but not piercing it. Accordingly the connecting elements 3 and 4 can have a marking 31, especially in the case of being inserted without the sleeve 9.

After aligning the sleeve 9 in the desired way it can be clamped in place in recess 5 or 6 using the locking device 10. The most simple and secure way to achieve this is by using clamping tongs 32 according to FIG. 14. The clamping tongs 32 are designed in such a way that, when the handles 33 are pushed together, the two jaws 34 are pushed apart so that two locking devices, positioned in opposition to each other, are pushed into the wall of recess 5 or 6. Preferably the leading guide 35 of one of the jaws 34 is designed in such a way that the jaws 34, inserted through the width of the recess 5 or 6, can be pushed apart far enough that they reach beyond that width and can, for example, reach behind the surface layer 23 of a surface 2 comprised of a lightweight building board. Preferably the jaws 34 are not only pushed apart to this purpose but guided some distance around the surface layer 23 to reach behind it. Thereby the locking devices 10—if this is necessary, especially for lightweight building boards with especially weak core—can be pivoted far enough around so that they can grip to the surface layer 23 from behind. For this purpose the guide 35 can comprise an intermediate part 37 linked with both an extension 36 of handle 33 and the jaw 34. In the present example the joint 38 connecting the intermediate part 37 with the jaw 34 is formed as a bolt and is guided as a curve in a crank 39. Other embodiments are possible, for example with a rail. It is essential that the radius of the curved crank 39 is selected in such a way that the locking device 10 can be reliably pivoted into the locking position without risk of being damaged. With the shown clamping tongs 32, two locking devices 10 positioned in opposition to each other can be activated at the same time. Therefore, with two movements of the clamping tong, a sleeve 9 with four locking devices 10 can be reliably clamped in place in the recess 5 or 6.

Then the connecting element 3 or 4 can be easily inserted into the sleeve 9 until it snaps in place in the position predetermined by the correct position of the sleeve 9. For comfortable and secure activation of the fastener of latch element 11 of locking device 8, as has been already explained by means of FIG. 4, a special securing key 40 according to FIGS. 15 and 16 is used. This tool comprises a handle 41 with a fork 42 with two or more teeth 43. Its free end can comprise an engaging part 44 which fits into a matching recess 45 of the latch element 11 of locking device 8; see FIG. 1. A bevel 46 adjacent to the engaging part 44 ensures that the bar 15 of the latch element 11 is pushed into the secure position, as can be seen on the left side of fig. and 4. Therefore, in case of a connecting element 3 or 4 with four locking devices 8 it is sufficient to press or tap the securing key 40 twice to fasten the connecting element 3 or 4 so securely in the sleeve 9 that it will not be loosened even when exposed to strong shocks or vibrations. It is self-evident, that a fork 42 with four teeth 43 positioned in pairs in opposition to each other would be possible whereby all four locking mechanisms 8 could be reached at the same time with one single use of the securing key 40.

According to the known state of the art, the connecting elements 3 and 4 can, according to FIGS. 4 and 5, comprise one hook 47 each, preferably a wedge hook. The connecting elements 3 and 4 are then each turned 180 degrees and arranged to each other in such a way that the hooks 47 can interlock. The connecting elements can furthermore designed in such a way that the hooks 47 can each only grip towards the center which requires that, for example, guiding bars on the connecting element 3 and/or 4 are to be provided. If the guiding bars are omitted, workpiece 1 remains movable sideways towards surface 2 to a certain degree which can be useful in some specific cases. To increase the load values of the connecting elements 3 and 4 a reinforcement element 48 can be inserted at the hook 47, made, for example, from metal. It can be attached by pressing or gluing.

Depending on the material of the workpiece 1 and especially the surface 2 and depending on the desired load value, an additional gluing of the sleeve 9 might be appropriate, for example with a two-component adhesive. For applying the adhesive, at least one opening can exist at the bottom of the sleeve 9, preferably, however, at the flange-shaped edge; see especially FIG. 8. Thereby the locking device 10 can be backfilled and a bigger pressure surface can be created.

Furthermore, due to the screwless mounting, it is possible to form the walls and the bottom of the connecting elements 3 and 4 in a closed or closeable manner. Possible perforations, resulting from the production of the connecting elements 3 and 4, can be closed with a closure 49. The closure can be designed in any desirable way. In this way the penetration of moisture through the walls or the bottom of the connecting elements 3 and 4 can be avoided. Moisture can often damage the unwaterproof core of workpiece 1 and even lead to the separation of veneer.

It is in the scope of the invention to design the described parts of the device and the tools differently than shown in the drawings. Connecting elements 3 and 4 could be provided insertable without the sleeve 9. The locking device 8 of the connecting elements 3 and 4 could be designed according to the locking device 10 of the sleeve 9 and be activated with the clamping tongs 32, if the geometry of the connecting devices 3 and 4 is adjusted accordingly. The connecting devices 3 and 4 or the sleeve 9 can comprise at least one insert of insulating, sound-absorbing and/or fire-retarding material on either side of its bottom.

The device according to the invention can be used in wood construction, especially in interior construction, store construction, furniture construction, door construction etc. Also in exhibition stand construction and in ship and metal construction. Elements of, for example, solid wood, sheet material, wall coverings, facings, sidings, decorative elements etc. can be mounted in that way. The device is especially useful when one of the surfaces to be connected is a lightweight building element.

1. Device for invisible and detachable connections of two surfaces whereof at least one surface belongs to a mobile workpiece (1) whereas at least two interlocking connecting elements (3, 4) are provided, of which a first connecting element is to be arranged on the workpiece (1) and a second one on the surface (2) to which the workpiece (1) is to be attached, wherein at least one of the connecting elements (3, 4) comprises at least one locking device (8) with the purpose of being able to clamp or grip the said connecting element (3, 4) to the workpiece (1) or to the surface (2) in its position, and wherein at least one sleeve (9), designed to receive the connecting element (3, 4), can be inserted in a recess (5, 6) of the workpiece (1) or the surface (2).

2. (canceled)

3. (canceled)

4. Device according to claim 1, wherein the sleeve (9) comprises at least one engaging site (14) for a locking device (8) of the connecting element (3, 4), for example in form of a notch or a punching in the wall of the sleeve (9).

5. Device according to claim 1, wherein the locking device (8) comprises a latch element (11).

6. Device according to claim 5, wherein at least one spring (13) holds the latch element (11) in the locked position.

7. Device according to claim 6, wherein the latch element (11) can be slideably moved into an unlocked position against the force of the spring (13).

8. Device according to claim 5, wherein the latch element (11) can be secured by a bar (15) in its locked position, whereupon this bar (15) can be moved from a releasing position, in which the latch element (11) can be moved freely, into a securing position in which the latch element is blocked.

9. Device according to claim 8, wherein the bar (15) rests in its securing position against a locking element (16) which is arranged in a stationary manner on the connecting element (3, 4).

10. Device according to claim 9, wherein the locking element (16) is designed in a step-like manner, so that the latch element (11) is freely movable prior to pushing down the bar (15) and rests against a step of the locking element (16) after being pushed down.

11. Device according to claim 1, wherein the locking device (8) or a latch element (11) of the locking device (8) comprises a slanted projection (12), with the purpose of pushing the locking device (8), when the connecting element (3, 4) is inserted, into a sleeve (9) or a recess (5, 6) into a released position and snapping it into position as soon as the connecting element (3, 4) reaches a predetermined position, for example as soon as a spring controlled latch element (11) reaches the area of the engaging site (14).

12. Device according to claim 1, wherein the walls and/or the bottom of at least one of the connecting elements (3, 4) or of one of the sleeves (9) designed to receive said elements is closed or designed to be closed.

13. Device according to claim 12, wherein at least one closure (49) to be inserted or screwed into an opening is provided.

14. Device according to claim 1, wherein the connecting elements (3, 4) comprise at least one hook (47) provided with an reinforcing part (48), made, for example, of metal, with the purpose of increasing the load values of the device.

15. Device according to claim 14, wherein the reinforcing part (48) is attached to the hook (47) by pressing or gluing.

16. Device according to claim 1, wherein the connecting elements (3, 4) comprise at least one insert of insulating, sound-absorbing and/or fire-retarding material.

17. Device according to claim 1, wherein the circumference of a connecting element (3, 4) and/or a sleeve (9), designed to receive such element, has markings (31) in the form of indentations which make the axle center (29) thereof recognizable.

18. Marking gauge for mounting a device according to claim 1, wherein a clamping device (18) is provided with the purpose of removably clamping the marking gauge (17) in a recess (5, 6) designed to receive a connecting element (3, 4).

19. Marking gauge according to claim 18, wherein claws or points (19) are provided, designed to be pressed into at least one bottom or one wall of the recess (6).

20. Marking gauge according to claim 18, wherein at least one clamping part (22) is provided that is designed to be placed against a wall or the edge of the recess (6).

21. Marking gauge according to claim 19, wherein at least one spring (21) is provided with which the claws or points (19) and/or at least one clamping part (22) can be pushed against the wall or the edge of the recess (6).

22. Marking gauge according to claim 21, wherein handle parts (20) are provided which are pushed apart by at least one spring (21); at their release the claws or points (19) and/or at least one clamping part (22) can be pushed against the wall or the edge of the recess (6).

23. Clamping tongs for mounting a device according to claim 1, wherein jaws (34) are provided, which can be pushed apart by activating the clamping tongs (32) in such a way that at least one locking device (8, 10) of a connecting element (3, 4) or of a sleeve (9) designed to receive such elements can be pushed into a locking position.

24. Clamping tongs according to claim 23, wherein the jaws (34) are designed in such a way and/or guided through a guide (35) that they can perform a motion reaching behind the width of a connecting element (3, 4) or of a sleeve (9) designed to receive such element.

25. Clamping tongs according to claim 24, wherein the guide (35) comprises at least one curved rail or crank (39) with the purpose of setting the respective jaw (34) into a curved pivoting motion.

26. Clamping tongs according to claim 25, wherein at least one intermediate part (37) is provided that is linked both with an extension (36) of a handle (33) and a jaw (34), wherein a joint (38) linking this intermediate part (37) with the jaw (34), for example a bolt, is guided in the curved rail or crank (39).

27. Securing key for mounting a device according to claim 1 wherein a fork with at least two teeth (42), positioned in opposition to each other, can activate the locking device (8) or a latch element (11) securing such device.

28. Securing key according to claim 27, wherein the teeth (43) comprise a slant (46), with the purpose of being able to push a bar (15) of the latch element (11) of the locking device(8) into a position that blocks such device from accidental loosening.

29. Marking tool for mounting a device according to claim 1, wherein a peg (28) is provided which is designed to be inserted into a recess (5, 6) of a workpiece (1) or a surface (2) and wherein an edge (30) is provided with the purpose of extending the axle center (29) of that peg (28) along the edge (30) in at least one direction with the purpose of being able to mark the axle center (29) of the peg (28) at the edge of the recess (5, 6).
